(19) United States
(12) Patent Application Publication
(10) Pub. No.: US 2007/0052187 A1
(43) Pub. Date: Mar. 8, 2007

(54) System and method for increasing the load capacity of a plastic wheelbarrow hopper

(75) Inventor: John H. Browder, Roanoke, TX (US)

Correspondence Address: Alan R. Thiele;Strasburger & Price, LLP, Suite 4400, 901 Main St., Dallas, TX, 75202, US

(73) Assignee: International Development Corporation

(21) Appl. No.: 11/220,143

(22) Filed: Sep. 6, 2005

(51) Int. Cl. B62B 1/00

(52) U.S. Cl. 280/47.31

(57) ABSTRACT

A system and method for increasing the load-carrying capacity and the service life of a wheelbarrow having a plastic hopper includes a first web attached to the outside surface at the front of the plastic hopper and a second web attached to the outside surface at the bottom of the plastic hopper.

### FIELD

The present invention pertains to yard and garden equipment; more particularly, the present invention pertains to a wheelbarrow having a plastic hopper.

### BACKGROUND

A wheelbarrow may be one of the oldest implements known to mankind—possibly dating back to a time shortly after the discovery of the wheel. The basic design of a wheelbarrow has not changed substantially since its invention. Specifically, in a wheelbarrow, one or two wheels are placed at the forward end of a pair of support struts. A handle fitted at the back end of each of the support struts facilitates both elevating the support struts and causing the wheel or wheels on the front end of the support struts to roll. Between the forward end and the back end of the support struts is a middle load-bearing portion. The middle load-bearing portion of the support struts is long enough to support a hopper or a tray. It is within the hopper or on top of the tray that a small heavy load may be transported by the wheelbarrow. This load may be most anything. In construction applications, the load may be bricks, rocks, cement, dirt, etc. In such construction applications, the hopper is typically made of a strong durable metal, such as steel.

Wheelbarrows have found great utility in residential yard and garden work for carrying plants, sod, and light construction materials. In an effort to reduce the cost and weight of wheelbarrows used for light duty residential yard and garden work, manufacturers have sought ways to make many of the parts of a wheelbarrow from light-weight, low-cost materials, such as plastic.

Modern plastic materials and modern plastic molding techniques have enabled molding wheelbarrow hoppers from various types of durable plastics. While such plastic wheelbarrow hoppers are suitable for light loads, it has been found that carrying heavy loads in a plastic wheelbarrow hopper dramatically decreases the service life of the plastic wheelbarrow hopper. Unfortunately, users of wheelbarrows made for light-duty residential yard and garden work do not typically buy heavy-duty wheelbarrows with a metal hopper when large loads are to be carried. Instead, there is a tendency on the part of some home owners to overload the plastic hoppers of a light-duty wheelbarrow. Such overloading causes the plastic hopper to break to where it can no longer be used or to crack - thus, shortening its useful service life.

Accordingly, there remains a need in the art for a system and method to increase the load-carrying capacity and service life of a light-duty wheelbarrow having a plastic hopper.

### SUMMARY

The present invention provides a system and method for increasing the load-carrying capacity and service life of a light-duty wheelbarrow having a plastic hopper.

It has been discovered that, if a web is placed on the outer surface of the front and of the bottom of the plastic hopper of a wheelbarrow, the load-carrying capacity and service life of the plastic hopper is increased.

### BRIEF DESCRIPTION OF THE DRAWING FIGURES

A better understanding of the system and method for increasing the load-carrying capacity of the plastic hopper of wheelbarrow may be had by reference to the drawing figures wherein:

FIG. 1 is perspective view of a prior-art two-wheeled wheelbarrow having a plastic hopper;

FIG. 2 is a front perspective view of a wheelbarrow having a plastic hopper with a web affixed to the front of the plastic hopper;

FIG. 3 is a bottom plan view of a wheelbarrow having a plastic hopper with a web affixed to the bottom of the plastic hopper;

FIG. 4 is a plan view of a web suitable for attachment to the front outer surface of the plastic hopper of a wheelbarrow;

FIG. 5 is a plan view of a web suitable for attachment to the bottom outer surface of the plastic hopper of a wheelbarrow.

### DESCRIPTION OF THE EMBODIMENTS

A wheelbarrow is a tool that is well known to most anyone who has worked in construction or has enjoyed working in a yard or garden. The construction of a wheelbarrow takes advantage of two simple machines which provide a mechanical advantage to a user who desires to lift and move small heavy loads.

The first simple machine is a wheel. The mechanical advantage provided by the wheel is that it takes less force to use a wheel when moving a load over a surface than to slide the load over the surface.

The second simple machine is a lever. The mechanical advantage provided by the lever is that less force is required to lift a load using a lever pivoted about a fulcrum than to lift the load directly.

In a wheelbarrow, one or two wheels are used to reduce the force needed to translate or move a load across a surface. In a wheelbarrow, a lever is used to enable the lifting of a larger load. The axle on which the wheel or wheels turn is the fulcrum about which the lever rotates. The lever itself is formed by the two support struts which are mounted to the axle on which the wheel or wheels are mounted. The hopper is mounted on the support struts. Once a load is placed in the hopper of a wheelbarrow, the user lifts up on the ends of the handles fitted to the support struts to elevate the load, and then the user exerts a pushing or pulling force on the handles to start the wheel or wheels of the wheelbarrow rolling in the desired direction.

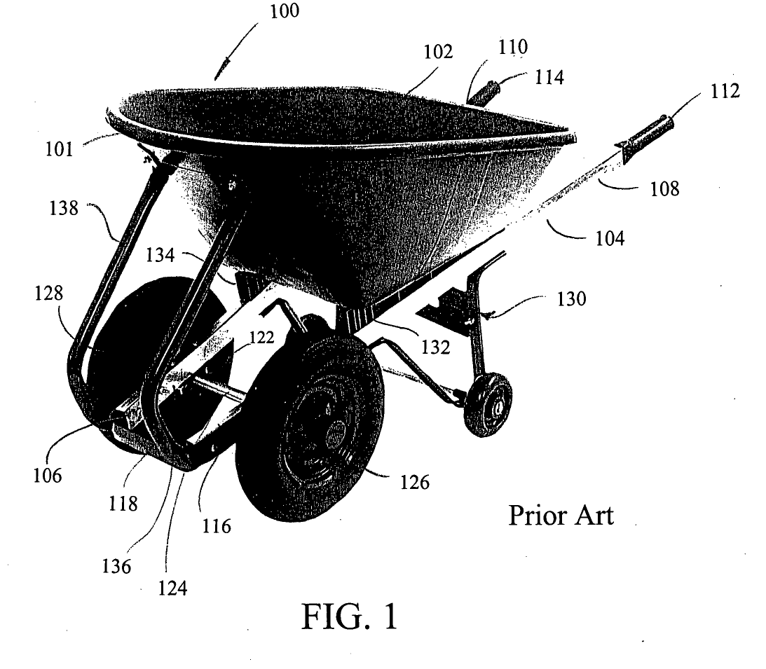

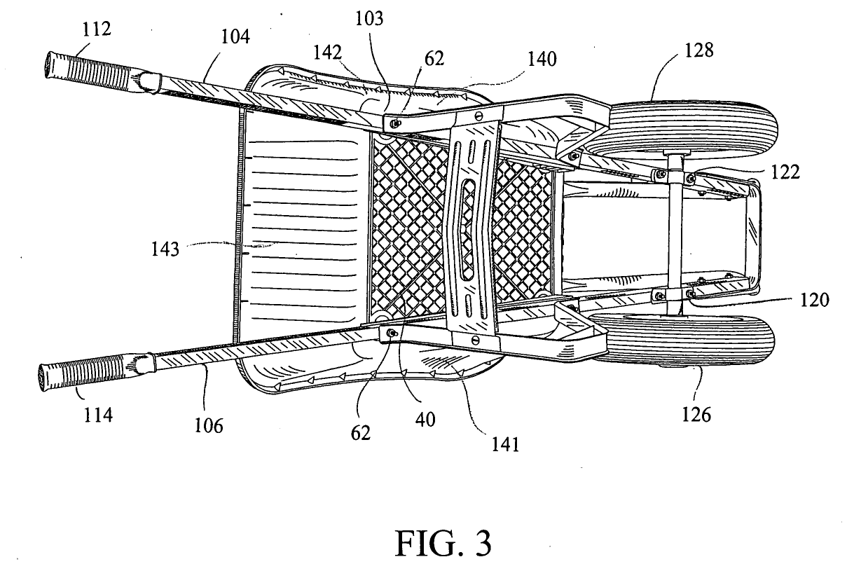

Wheelbarrows come in many shapes, sizes and configurations. Shown in FIG. 1 is a prior-art two-wheeled wheelbarrow 100 having a plastic hopper 102. The plastic hopper 102 is supported by two support struts 104, 106. At the distal or back end 108, 110 of the support struts 104, 106 are the handles 112, 114 that are spaced horizontally and vertically to enable both easy gripping and lifting by the user of the wheelbarrow 100. At the proximal or forward ends 116, 118 of the support struts 104, 106 is located a pair of supports 120, 122 for an axle 124 which enables rotation of the wheels 126, 128. In the wheelbarrow 100 illustrated in FIG. 1, the axle 124 extends beyond the support struts 104, 106 so that two wheels 126, 128 may be used. If a single wheel is used, the single wheel is typically mounted on an axle in the space between the support struts. Also, in the wheelbarrow 100 illustrated in FIG. 1 is a wheeled support assembly 130 on which the wheelbarrow rests when it is not moving. A non-wheeled support assembly 131, as shown in FIG. 3, may be used.

The two-wheeled wheelbarrow 100, as shown in FIG. 1, provides greater stability and reduces the tendency of the wheelbarrow 100 to tip over when an uneven load is placed in the hopper. Further, and as shown in FIG. 1, the plastic hopper 102 is supported by leveling pieces 132, 134 placed between the top of the support struts 104, 106 and the bottom of the hopper 102. Additional support may be provided by front braces 136, 138 which are mounted to the outside of the proximal end of the support struts 104, 106 and extend upwardly to connect with the front portion 101 of the hopper 102.

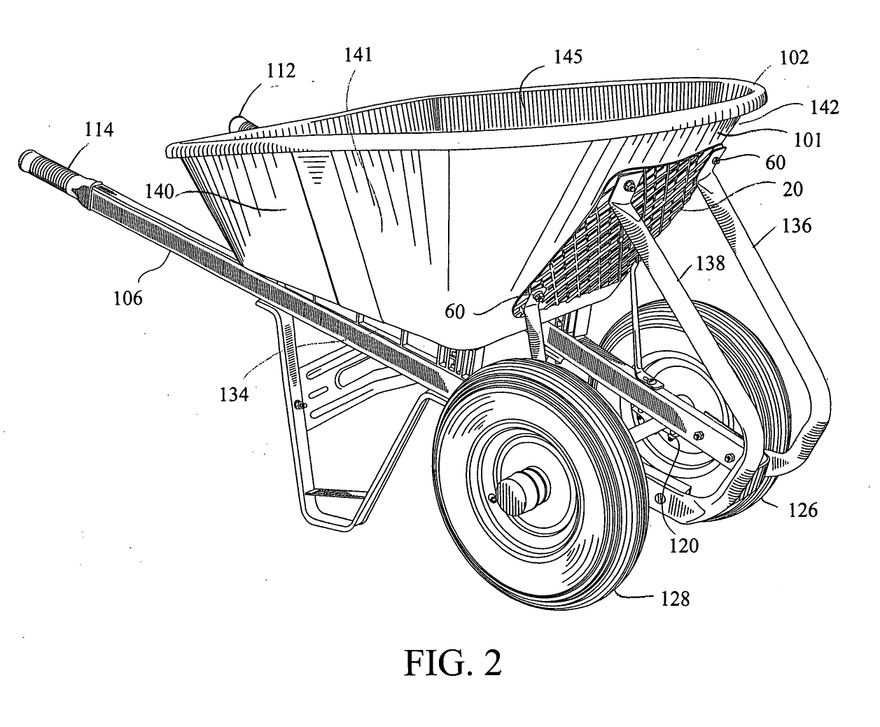

While the wheelbarrow 100 shown in FIG. 1 is suitable for light-duty yard and garden use, some owners of such light-duty wheelbarrows often desire to repetitively carry heavy loads close to the load-carrying capacity of the plastic hopper 102. This practice of carrying such loads will either break the plastic hopper 102 or significantly decrease its service life. Accordingly, the need has arisen for a system and method to both add to the load carrying capacity and increase the service life of a plastic wheelbarrow hopper 102. This need has been met by the present invention which, in its preferred embodiment, includes adding a first web 20 to the outside of the front portion 101 of the plastic hopper 102 (FIG. 2) and adding a second web 40 to the outside of the bottom portion 103 of the plastic hopper 102 (FIG. 3).

It has been found that, by adding a web 20 to both the front portion 101 of a plastic wheelbarrow hopper 102 and to the bottom portion 103 of a plastic wheelbarrow hopper 102, a significant increase in the load-carrying capacity and the service life of the plastic hopper 102 is obtained.

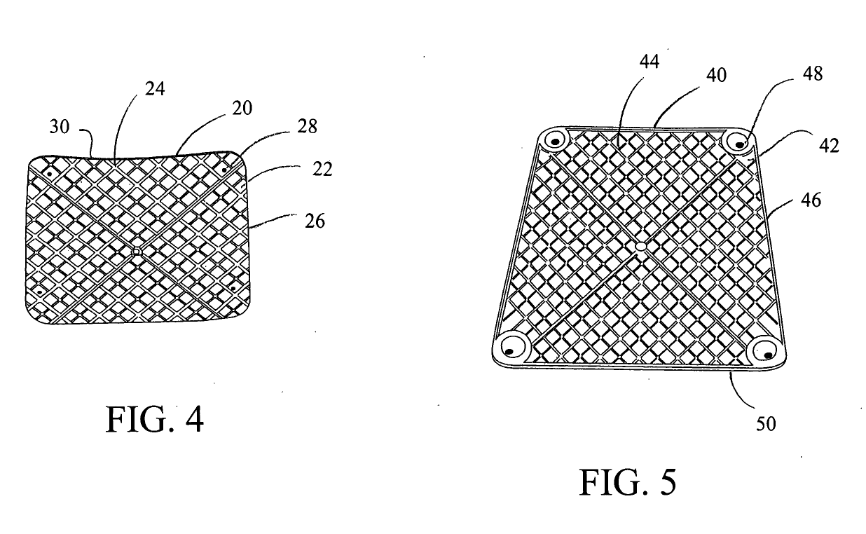

The webs 20, 40 which are attached to the bottom portion 103 and to the front portion 101 of the plastic hopper 102 are shown in FIGS. 4 and 5, respectively. Therein, it may be seen that each web 20, 40 includes a solid portion 22, 42 on which is overlayed a mesh portion 24, 44. The perimeters 26, 46 of the webs follow the perimeters of the front portion 101 and of the bottom portion 103 of the plastic hopper 102, respectively. As shown in FIG. 2, the attachment of the web 20 to the front portion 101 of the plastic hopper 102 uses the mounting hardware 60 employed for the support of the plastic hopper 102 and the wheels 126, 128. Alternatively, additional mounting hardware may be used. Similarly, in FIG. 3, the mounting hardware 62 used to attach the plastic hopper 102 to the support struts 104, 106 is used to attach the web 40 to the bottom portion 103 of the plastic hopper 102.

On top of the solid portion 22, 42 is a mesh 24, 44. In the illustrated embodiment, the mesh 24, 44 is based on a diamond pattern. Those of ordinary skill in the art will understand that most any mesh pattern may be used having openings with either linear or arcuate sides. The openings in the mesh 24, 44 are based on the size, the thickness, and the type of material from which the web is made. If the web is made from plastic, those of ordinary skill in the art of designing plastic forms will understand how to maximize the strength of the web 20, 40 with a mesh 24, 44 overlay while minimizing the amount of plastic material used to form the web 20, 40. The holes 28, 48 formed in the web are sized and spaced for insertion of the mounting hardware 60, 62. Additional mounting holes may be added, if needed.

Best results are obtained when the inside surface 30, 50 of the solid portion 22, 42 of the web 20, 40 is in contact with the outside surface 140 of the plastic hopper 102. Thus, if there is a curve to either the front portion 103 of the plastic hopper 102 or the bottom portion 103 of the plastic hopper 102, the web 20, 40 should be formed to either match this curve or be made from a material that is flexible enough to bend to follow the curve when attached to the plastic hopper 102.

In the preferred embodiment, the web 20, 40 is made from the same plastic as the plastic hopper 102. However, those of ordinary skill in the art will realize that the web 20, 40 may be made from a wide array of plastics or plastic composites or even metal.

In actual use, sizing the web 20, 40 to cover about 80% of the area on the front portion 101 or on the bottom portion 103 of the plastic hopper 102 has provided satisfactory results.

While the preferred embodiment of the system and method of the disclosed invention 10 shows the webs 20, 40 attached to the outside surface 140 of the front portion 101 and of the bottom portion 103 of the plastic hopper 102, those of ordinary skill in the art will understand that additional load-carrying capacity can be added if webs are also added to the sides 141, 142 and rear 143 of the plastic hopper 102, in addition to the front portion 101 and bottom portion of the plastic hopper 102.

While the preferred embodiment of the system and method of the disclosed invention show the webs 20, 40 attached to the outside surface 140 of the front portion 101 and bottom portion 103 of the plastic hopper 102, those of ordinary skill in the art will realize that the webs may be attached to the inside surface 145 of the plastic hopper 102. However, such mounting may interfere with the use of plastic hopper 102 or subject the web to breakage from the impact of stones or bricks being loaded into the plastic hopper 102 or the use of a shovel to unload the plastic hopper 102.

Those of ordinary skill in the art will understand that the webs 20, 40 are replaceable in the event of inadvertent breakage or damage.

While the system and method of the disclosed invention to increase the load capacity and service life of a plastic wheelbarrow hopper has been disclosed by reference to its preferred and alternate embodiments, those of ordinary skill in the art will understand that still other embodiments of the disclosed invention have been enabled by the foregoing disclosure. Such other embodiments shall be included within the scope and meaning of the appended claims.

I claim:

1. A wheelbarrow comprising:
a pair of support struts, each support strut including a front portion, an elongated central portion, and a rear portion;
a plastic hopper having an inside surface, an outside surface, a bottom, a front, a back, and a pair of sides;
said front portion of said support struts providing a mounting for at least one wheel;
said rear portion of said support struts including hand grips;
said elongated central portion of said support struts constructed and arranged for support of said plastic hopper;
a first web affixed to the outside surface of said front of said plastic hopper;
a second web affixed to the outside surface of said bottom of said plastic hopper.

2. The wheelbarrow as defined in claim 1 wherein said first and second webs include a solid portion and a mesh portion.

3. The wheelbarrow as defined in claim 2 wherein said first and second webs are molded from the same plastic as said plastic hopper.

4. An improved wheelbarrow having a plastic hopper, said improvement comprising:
a first web affixed to the outside surface of the plastic hopper at the front of the plastic hopper; and
a second web affixed to the outside surface of the plastic hopper on the bottom of the plastic hopper.

5. The improved wheelbarrow as defined in claim 4 wherein said first and second webs include a solid portion and a mesh portion.

6. The improved wheelbarrow as defined in claim 5 wherein said first and second webs are molded from the same plastic as the plastic hopper.

7. A method of improving the strength of a plastic hopper used on a wheelbarrow, said method comprising the steps of:
affixing a first web to the outer surface of the front of the plastic hopper;
affixing a second web to the outer surface of the bottom of the plastic hopper.

8. The method as defined in claim 7 wherein said first and second webs have a solid portion and a mesh portion.

9. The method as defined in claim 8 wherein said first and second webs are molded from the same material as the plastic hopper.

10. A system for increasing the load-carrying capacity of the plastic hopper of a wheelbarrow, said system comprising:
a first web constructed and arranged from attachment to the outer surface of the front of the plastic hopper;
a second web constructed and arranged for attachment to the outer surface of the bottom of the plastic hopper.

11. The system as defined in claim 10 wherein said first web and said second web include a solid portion and a mesh portion.

12. The system as defined in claim 11 wherein said first and second webs are molded from the same material as the plastic hopper.

13. A web for increasing the carrying capacity of the plastic hopper of a wheelbarrow, said web comprising:
a perimeter constructed and arranged to be substantially parallel to the perimeter of the front of the plastic hopper;
a plurality of attachment points located within said perimeter for attaching the web to the outside surface of the front of the plastic hopper;
a solid portion and an overlying mesh formed within said perimeter;
whereby the web covers a substantial portion of the area of the front of the plastic hopper.

14. The web as defined in claim 13 wherein the web is molded from the same material as the plastic hopper.

15. A web for increasing the carrying capacity of the plastic hopper of a wheelbarrow, said web comprising:
a perimeter constructed and arranged to be substantially parallel to the perimeter of the bottom of the plastic hopper;
a plurality of attachment points located within said perimeter for attaching the web to the outside surface of the bottom of the plastic hopper;
a solid portion and an overlaying mesh formed within said perimeter;
whereby the web covers a substantial portion of the area of the bottom of the plastic hopper.

16. The web as defined in claim 15 wherein the web is molded from the same material as the plastic hopper.
